(19) United States
(12) Patent Application Publication
(10) Pub. No.: US 2023/0234831 A1
(43) Pub. Date: Jul. 27, 2023

(54) OVERFILL SPILL PREVENTION DEVICE FOR FUEL DISPENSING NOZZLES

(71) Applicant: Julian E. Cannon, Brandon, FL (US)

(72) Inventor: Julian E. Cannon, Brandon, FL (US)

(21) Appl. No.: 17/803,041

(22) Filed: Jan. 25, 2022

(51) Int. Cl. B67D 7/54; B67D 7/32

(52) U.S. Cl. CPC B67D 7/54; B67D 7/3227; B67D 7/3209

(57) ABSTRACT

A filler neck adaptor for use with manually operated fuel dispensing nozzles. Adaptor provides a visual cue that a target fuel level in the tank has been reached during tank filling operations. Adaptor comprises a flanged extension tube with an overflow reservoir sealed to the upper surface of the flange. A slidably adjustable securement ring is mounted on the extension tube. The securement ring is designed to mate with tank closure features on the filler neck. An airlock tank seal is installed on the lower surface of the securement ring to establish a seal between the securement ring and the tank filler neck. During filling displaced air in the tank is forced to exit the tank via an air vent passageway between the nozzle and the inside surface of the adaptor extension tube. As the rising fuel level in tank nears the distal end of the extension tube, wisps of fuel becomes entrapped in the airstream and become visible in the transparent overflow reservoir. This visual cue that the tank is full allows the operator to stop fuel flow prior to overflow spillage.

### BACKGROUND—PRIOR ART

The following is a tabulation of some prior art that presently appears relevant:

| | | U.S. Patents | |
|---|---|---|---|
| Patent Number | Kind Code | Issue Date | Patentee |
| 20070169845 | A1 | July 2007 | Benjey |
| 9,315,099 | B2 | April 2016 | Whelan |
| 20090194198 | A1 | August 2009 | Bar |
| 20050126657 | A1 | June 2005 | Allman |
| 9,776,506 | B2 | October 2017 | Whelan |
| 20080142114 | A1 | June 2008 | Cook |
| 5,074,343 | A | December 1991 | Tyree |
| 4,55,9984 | A | December 1985 | Wycech |
| 8,086,589 | B2 | November 2011 | Novak |
| 5,488,168 | A | October 1995 | Lindgren |
| 5,445,196 | A | August 1995 | Tyree |

### NONPATENT LITERATURE DOCUMENTS

https://motorglideraccessories.com/products/fuel-level-funnel-for-pipistrel-aircraft

### BACKGROUND OF THE INVENTION

### 1. Field of Invention

The present invention relates to devices which give an indication during tank filling that liquid level in a tank has reached a target level, prior to overflow spillage. It more specifically relates to devices which provide visual or other cues to an operator filling a fuel tank designed with a short filler neck using a pressure-fed, manually operated fuel dispensing nozzle.

Fuels in general, and gasoline fuels in particular, are flammable, toxic, and environmentally hazardous liquids. It is, therefore, important for fueling operators to be able to stop fuel flow reliably when a tank is full before overflow occurs. For many fuel tanks this may be accomplished through use of an automatic cut-off nozzle. These nozzles are designed with a fluid level sensor port located near the nozzle's distal end. When the sensor port becomes covered in liquid, a flow cutoff valve located within the nozzle's handheld body is actuated to immediately stop fuel flow.

Use of automatic cut-off nozzles, when properly used, has effectively eliminated overflow spillage from land vehicle fuel tanks. These tanks are designed to have filler necks long enough for the distal end of the nozzle and the level sensor port to remain entirely within the filler neck without protruding into the interior of the tank. Therefore, during filling, the tank is completely filled before the fuel level reaches the sensor port. When fuel level reaches the sensor port, fuel flow is automatically stopped prior to overflow spillage.

Tanks designed with a filler neck short enough to allow the level sensor of an automatic dispensing nozzle to protrude into the tank will not be filled completely at automatic flow stoppage unless the nozzle's sensor location is accurately positioned within the filler neck. There are many examples of fuel tanks designed with filler necks too short to effectively utilize automatic cut-off fuel dispensing nozzles, fuel caddies, jerry cans, small engine tanks, and small general aviation (GA) aircraft fuel tanks, for example. Among these, small GA aircraft fuel tanks present unique factors which not only contribute to the likelihood of fuel spillage, but also make spillage prevention a very serious issue. These factors will be discussed in detail below.

First, the most widely used small general aviation aircraft fuel, 100 octane low lead gasoline (100LL), contains tetraethyl lead (TEL) additives. All forms of lead are toxic to humans and animals if inhaled or ingested, and there is no known safe level of lead exposure. While 100LL burned in aircraft engines widely distributes its lead content into the atmosphere, spilled fuel performs no useful purpose, and if not carefully contained, results in concentrated areas of permanent ground and water contamination. The lead added to leaded gasoline does not evaporate.

Second, small general aviation aircraft fuel tanks are almost exclusively located just below a wing skin surface or a fuselage skin surface. Some aircraft are designed to have a “wet wing” tank where the wing skin also serves as a fuel tank surface. These tanks have very short filler necks, sometimes only a fraction of an inch long. Therefore, it is not normally possible to position the distal end of an automatic cut-off fuel dispensing nozzle within the filler neck deeply enough or precisely enough for the dispensing nozzle's sensor to detect a rising fuel level before overflow occurs. As a result, general aviation fueling stations are rarely equipped with automatic cut-off fuel dispensing nozzles, requiring the fueling of small general aviation aircraft tanks to be necessarily a manually controlled operation. Fuel flow start, flow rate control, fuel level, and flow stoppage are completely dependent upon a fueling operator's skill, judgment, and ability to see or otherwise sense the rising fuel level during filling. Since not all fueling operators are highly skilled, fueling overflow spillage due to operator error is not an uncommon occurrence.

Third, the following factors further contribute to the likelihood of error and fuel spillage during fueling operations for small GA aircraft:
1. During fueling, the dispensing nozzle seriously obstructs a fueling operator's view into the tank. An operator may sometimes attempt to lift and suspend the dispensing nozzle above the filler neck to increase the viewing area.
2. Aircraft fueling usually occurs in outside daylight conditions when sunlight reflections from the wing surfaces can seriously diminish the ability to see the fuel level within the tank.
3. Aircraft fuels are transparent making it difficult to see surface reflections even in ideal settings.
4. High wing aircraft tanks require viewing into the tanks from a ladder.
5. Aircraft having curved upper tank surfaces can cause unexpected rapid fuel level increases as the fuel level nears the distal end of the filler neck. These rapid fuel level increases also occur when fueling tail-wheel aircraft due to the wing tanks being tilted.
6. Pilots have a desire to completely fill tanks to maximize available fuel during flights and often encourage fueling operators to fill the tank completely to the neck.

It is to be noted that the present invention can be used effectively in preventing overfill spills of liquids other than fuels.

### 2. Prior Art

Prior to the present invention, there are few methods available to the fueling operator to determine when a short filler neck tank is about to overflow. The presently most-used method is for the operator to attempt to observe the rising fuel level in the tank via a crescent-shaped gap between the inside diameter of the filler neck and the outside diameter of the dispensing nozzle and stop the flow when the fuel level reaches the distal end of the filler neck. Unless extreme care is taken, this method can lead to fuel spillage before overflow occurs.

One prior art device for presenting visual fuel level cues to a fueling operator is a fueling funnel. The chief advantage of a fueling funnel is that the fueling operator's view into the tank is not obstructed by the nozzle; it can be held well above the filler neck, allowing fuel level observation within the funnel spout. The disadvantages of fueling funnels are (1) the fuel flowing into the tank via the funnel spout blocks the view of the fuel level in the tank and (2) if the dispensing nozzle delivers fuel at a faster rate than the funnel allows gravity fuel flow into the tank, the fuel level in the tank is not visible at all. Fueling funnels are used primarily for transferring fuel from a jerry can to a fuel tank.

There are funnels designed to incorporate a float actuated level indicator within the funnel; however, these funnels are necessarily low flow rate devices and quite often are designed so that the float is mounted well below the filler neck inlet. There are presently no known commercial funnels suitably designed to significantly reduce fuel overfill spills when fueling with high flow rate hoses and dispensing nozzles.

There are presently no additional known devices which provide visual cues to a fueling operator using pressure-fed manually operated fuel dispensing nozzles to fill tanks designed with short filler necks.

### Objects and Advantages

Accordingly, it is an object of the present invention to provide a filler neck adaptor which can provide a visual cue to a fueling operator that the fuel level in the tank being filled has reached a target fuel level prior to overfill spillage. It is a further an object of the present invention to relieve the fueling operator of the necessity of peering into the small crescent-shaped gap to monitor the rising fuel level. It is a further object of the present invention to provide a cue visible from the side of the filler neck of an elevated tank. It is a further object of the present invention to relieve the fueling operator of the necessity of raising the fuel dispensing nozzle above the neck during filling to better see the fuel level within the tank. It is a further object of the present invention to reduce the requirement for highly skilled fueling operators in order to fill a tank to a target level prior to overfill spillage.

In summary, it is an object of the present invention to provide a device, a filler neck adaptor for giving visual cues to a fueling operator that prevent fuel spills when fueling tanks designed with short filler necks using a pressure fed, manually operated fuel dispensing nozzle.

### LIST OF REFERENCE NUMERALS

The following numbering is used throughout the drawings.
1. Filler neck adaptor
2. Filler neck
3. Tank surface
4. Fuel dispensing nozzle
11. Overflow reservoir
12. Extension tube flange
13. Extension tube
14. Securement ring
15. Tank seal
16. Depth setting screw
17. Securement lug
21. Overflow reservoir access opening
22. Extension tube proximal opening
23. Extension tube distal opening
24. Air venting passageway
25. Nozzle distal opening
26. Filler neck opening
27. Fuel level
28. Reservoir interior

### BRIEF DESCRIPTION OF THE DRAWINGS—FIGS. 1 TO 5

FIG. 1 is a perspective view of the preferred embodiment of a filler neck adaptor designed to provide visual cues to an operator during tank filling.

FIG. 2 is a cross-sectional view of the preferred embodiment of a filler neck adaptor of FIG. 1.

FIG. 3 is an illustrative drawing of view of the filler neck adaptor of FIG. 1 installed on the filler neck of an aircraft wing tank. A fuel dispensing nozzle is shown inserted through the filler neck adaptor, into an aircraft wing tank.

FIG. 4 is a cross-sectional view of the filler neck adaptor of FIG. 1.

### DETAILED DESCRIPTION OF THE INVENTION

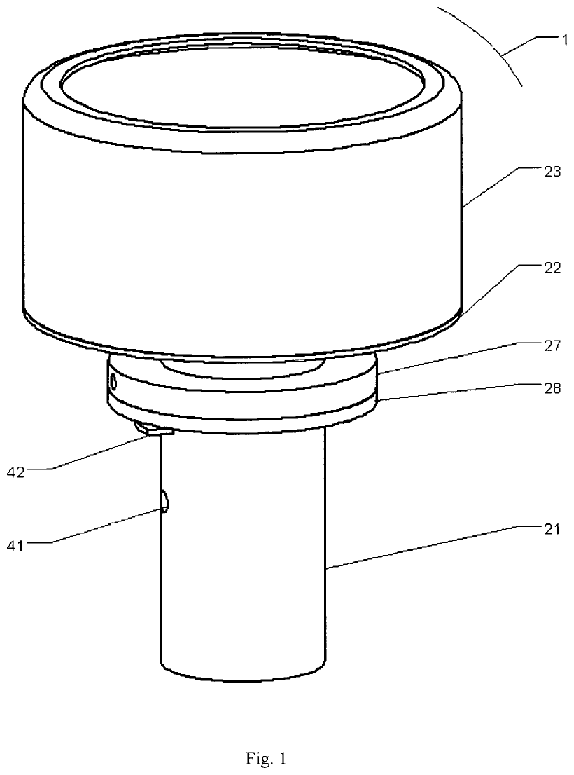

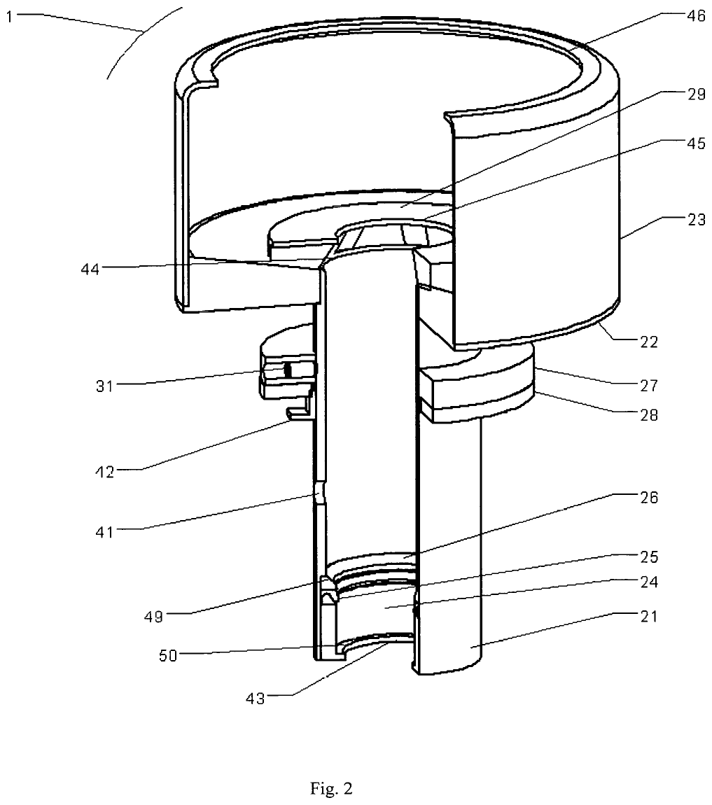

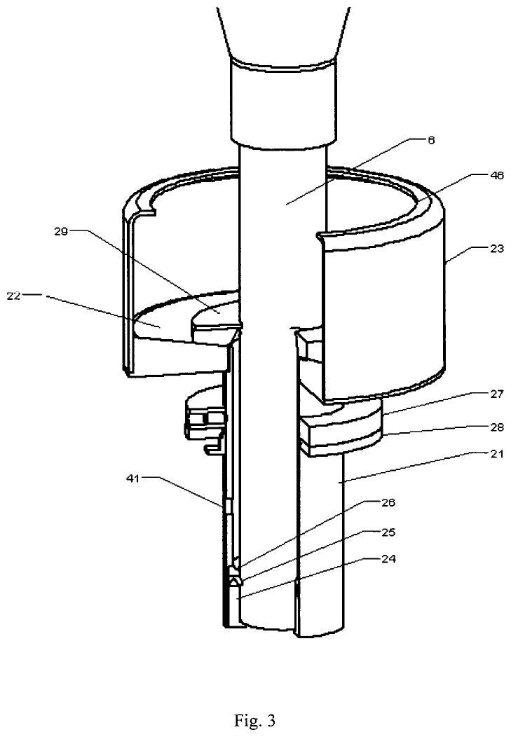

Referring to the drawings, the preferred embodiment of the present invention is disclosed and illustrated in FIGS. 1 and 2.

FIG. 1 shows a perspective view of the present invention disclosed herein, a filler neck adaptor 1 comprising a mostly transparent overflow reservoir 11, extension tube flange 12, extension tube 13, securement ring 14, tank seal 15, and depth setting screw 16.

FIG. 2 is a half-section view of the present invention. Overflow reservoir 11 comprises a generally cylindrical transparent compartment with an access opening 21 in its upper surface. An extension tube flange 12 forms the lower surface of the reservoir. The extension tube flange 12 is sealed both to the lower part of overflow reservoir 11 and to the outside surface of extension tube 13. Securement ring 14 is adjustably mounted on extension tube 13.

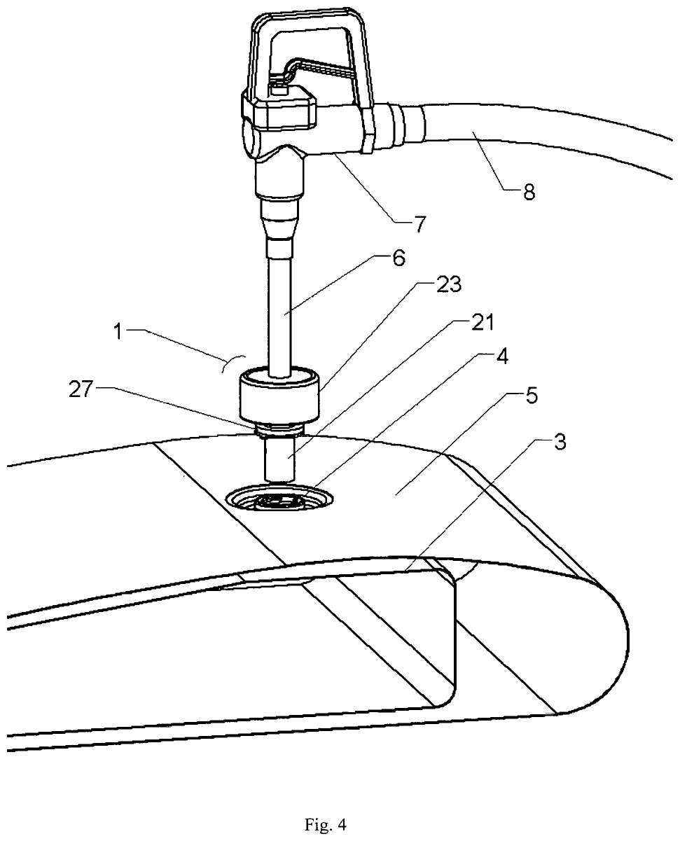

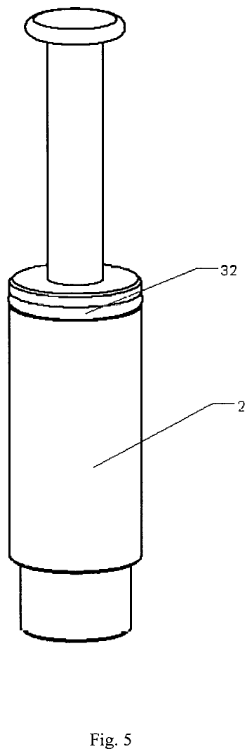

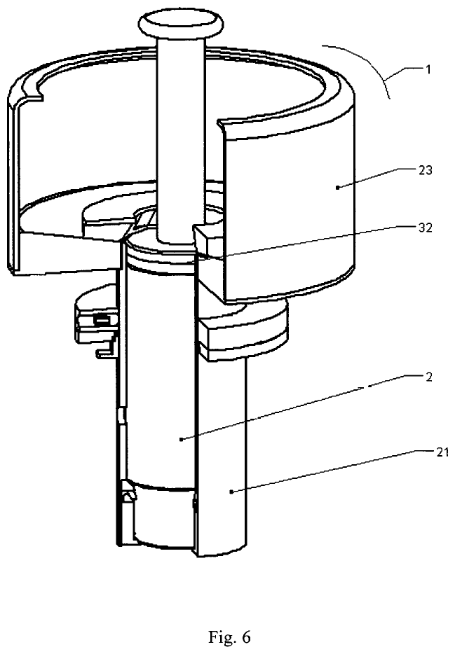

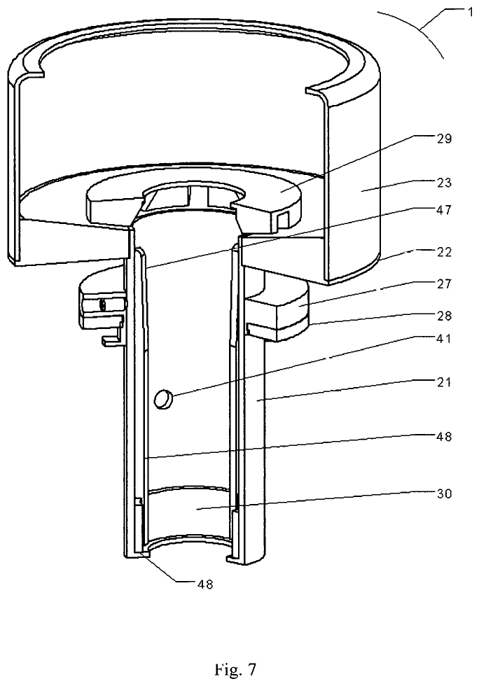

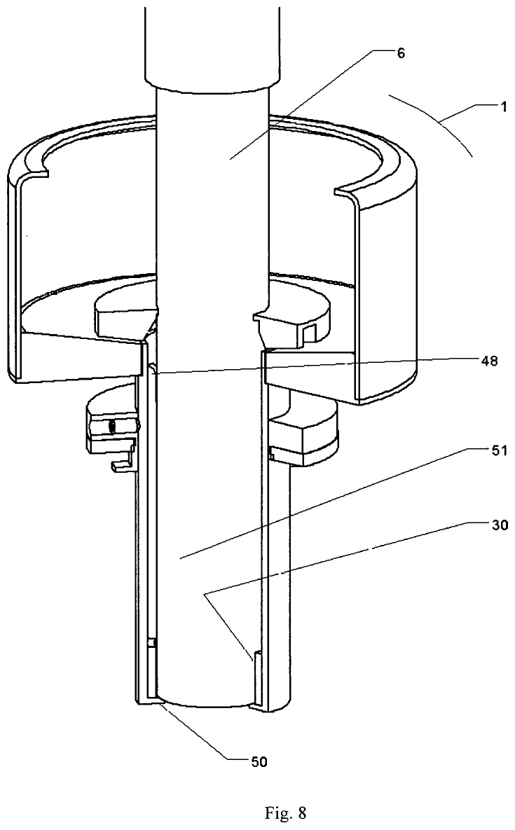

Securement ring 14 may be adjusted axially on extension tube 13 to and can be anchored in place using depth setting screw 16. The axial adjustment of securement ring 13 is used to set the depth to which the distal opening 23 of extension tube 13 extends into the tank being fueled (FIG. 4). Tank seal 15, installed on securement ring 14, is designed to form a temporary seal between filler neck adaptor 1 and tank filler neck 2. Securement lug 17, integral with securement ring 14, is designed to mate with features (not shown) of filler neck 2 to releasably secure filler neck adaptor 1 to filler neck 2.

FIG. 3 is an illustrative drawing showing filler neck adaptor 1 installed on filler neck 2 of an aircraft wing tank 3. A fuel dispensing nozzle 5 is shown inserted through filler neck adaptor 1 into an aircraft wing tank 3.

FIG. 4 is a half-sectional view of filler neck adaptor 1 installed on the filler neck 2 of an aircraft wing tank 3. A fuel dispensing nozzle 5 is shown inserted through filler neck adaptor 1 and into an aircraft wing tank 3.

Extension tube 13 is designed to fit easily into the inlet opening of tank filler neck 2 and to allow a non-restrictive annular air venting passageway 24 from the extension tube proximal opening 22 and the extension tube distal opening 23 of nozzle extension tube 13. Device securement ring 14 incorporates locking tabs 17, or equivalent features, for the purpose of engaging mating locking features in tank filler neck 2. Set screw 16 is installed in adaptor securement ring 14 for the purpose of locking support ring 14 in position on nozzle extension tube 13. Typical aviation fuel dispensing nozzles are approximately 6 inches long, and the overall length of one embodiment of the present design is approximately 5 inches. The overall length of nozzle extension tube 13 is approximately 3 inches. This length be made longer or shorter to accommodate specific tank filler neck lengths.

In the preferred embodiment of the present design, a static electricity discharge path is provided by constructing nozzle extension tube 13, and device support ring 14 of an electrically conductive material, aluminum, steel, or brass, for example. It is desirable to construct overflow reservoir 11 of a transparent non-breakable material, polyethylene terephthalate glycol (PETG), for example. All other components may be made of any convenient material compatible with gasoline.

### Operation

To understand the operation of the preferred embodiment of the present design it is helpful to refer to FIG. 3. A refueling operator removes the fuel tank's closure cap (not shown) and replaces the closure with the filler neck adaptor 1. The operator then inserts a fuel dispensing nozzle 5 completely through the overflow reservoir access opening 21, through extension tube 13, and into the fuel tank (fuel tank surface 3 is shown). The operator then opens the nozzle's flow control valve and commences filling the fuel tank. As the tank fills, air within the tank is expelled via an air venting passageway 24 formed between the dispensing nozzle 5 and the inside surface of the extension tube 13. As the fuel level 27 in the tank nears the extension tube distal opening 23, wisps of fuel and then a bolus of fuel will be swept into overfill reservoir interior 28. This bolus of fuel provides a visual cue that the fuel level in the tank has reached its target level coincident with the extension tube distal opening 23, allowing the operator to release the dispensing nozzle's flow control valve. The small amount of fuel now in overflow reservoir 11 will drain back into the fuel tank as the operator removes the fuel dispensing nozzle 5 from the filler neck adaptor 1. Finally, the operator removes the filler neck adaptor 1 and replaces the tank's closure. The target level in the tank may be adjusted by sliding and re-setting securement ring 14 position on extension tube 13 to allow a shallower or deeper protrusion of the extension tube distal opening 23 into the fuel tank.

### SUMMARY

The present invention comprises a filler neck adaptor mountable onto the filler neck of a fuel tank for the purpose of aiding a refueling operator using a manually controlled, pressure-fed fuel dispensing nozzle in filling a tank to a target level. The tank filler neck adaptor disclosed herein is particularly useful in refueling tanks which do not allow effective use of an automatic cut-off dispensing nozzle, namely tanks which are designed with relatively short filler necks. The filler neck adaptor provides a visual cue to a fueling operator that the rising fuel level in a tank being filled is nearing or has reached a target level so that fuel flow may be manually stopped. Generally, the target level is that level at which the tank is full, just before the onset of overflow spillage.

The preferred embodiment of the filler neck adaptor comprises a flanged extension tube with an overflow reservoir sealed to the upper surface of the flange. A slidably adjustable securement ring is mounted on the extension tube. The securement ring is designed to mate with tank closure features on the filler neck. An airlock tank seal or gasket is installed on the lower surface of the securement ring to establish a seal between the securement ring and the tank filler neck. The tank seal forces air being displaced by fuel to exit the tank via the space between the outside surface of the nozzle and the inside surface of the adaptor extension tube. As the rising fuel level in tank nears the distal end of the extension tube, wisps of fuel will become entrapped in the airstream and become visible in the transparent overflow reservoir. This visual cue that the tank is full allows the operator to stop fuel flow prior to overflow spillage.

I claim:

1. A filler neck adaptor mountable to the filler neck of a tank fillable via a fluid dispensing nozzle, said filler neck adaptor giving a visual cue during filling of the tank that a target fluid level within the tank has been reached, said filler neck adaptor being open to allow a dispensing nozzle to extend therethrough into the tank, said filler neck adaptor comprising:
a transparent overflow reservoir having a proximal end and a distal end, wherein said proximal end is open to receive a dispensing nozzle;
a flanged extension tube axially extending downward from and fluidly sealed to said distal end of overflow reservoir;
a securement ring with locking features compatible with mating features on said tank filler neck;
a tank seal mounted on said securement ring to establish a fluid seal between said securement ring and said tank filler neck.
